(19) United States
(12) Patent Application Publication
(10) Pub. No.: US 2026/0158814 A1
(43) Pub. Date: Jun. 11, 2026

(54) TINDER PENCIL

(71) Applicant: Outdoor Element, LLC, Englewood, CO (US)

(72) Inventor: Michael John Mojica, Englewood, CO (US)

(73) Assignee: Outdoor Element, LLC, Englewood, CO (US)

(21) Appl. No.: 19/181,089

(22) Filed: Apr. 16, 2025

Related U.S. Application Data
(60) Provisional application No. 63/634,769, filed on Apr. 16, 2024.

(51) Int. Cl. B43K 19/00; B43K 29/00

(52) U.S. Cl. CPC B43K 19/00; B43K 29/00

(57) ABSTRACT

A tinder pencil, including an outer casing configured to be shaved, scraped, or broken to produce flammable tinder and a writing component enclosed within the outer casing. The outer casing is enriched with wax or resin to improve flammability of the produced tinder. The pencil may include a ferrule to attach one or more of an eraser, a striker, a ferrocerium nub, and a pocket clip. A clear coat may be applied to prevent the wax or resin from leaching out of the tinder pencil.

### CROSS-REFERENCE TO RELATED APPLICATIONS

This patent application claims priority of U.S. Provisional Patent Application No. 63/634,769, entitled “TINDER PENCIL,” filed April 16, 2024, which is hereby incorporated by reference in its entirety.

### FIELD OF THE DISCLOSURE

The present disclosure relates to fire-starting tools, including a pencil having an outer casing configured to produce flammable tinder.

### BACKGROUND

Being able to initiate and sustain a fire, particularly in outdoor settings and challenging circumstances, is often crucial for survival. Hypothermia stands as the primary threat to life in the wilderness. Even in scorching desert locales, nighttime temperatures can plummet, leading to hypothermia-related fatalities. The warmth emanating from a fire serves to regulate the body's core temperature, offering vital thermoregulation. Beyond its life-preserving function for both animals and humans, fire serves a myriad of purposes, including food preparation, smoke generation for food preservation, sterilization of materials, water purification, crafting pottery and tools, illumination, insect and predator deterrence, and as a distress signal.

However, it can be difficult to start and sustain a fire if a user does not have adequate tools. A user may not have sufficient heat and fuel to reach the ignition temperature of the fuel, and some materials are harder to ignite than others.

### SUMMARY

Various aspects of this disclosure relate to a pencil configured such that the result of abrasion is a flammable tinder. The shavings produced when the pencil is sharpened serve as effective tinder for starting fires. Additionally, the outer casing of the pencil can be scraped, rubbed, grinded, or otherwise abrased to create shavings that ignite easily with a spark or lighter. Such a pencil can be an invaluable addition to an outdoorsman’s kit where minimization of weight and space is a vital concern.

In some embodiments, the outer casing of the pencil may be enriched with resin and constructed using natural wood such as, but not limited to, pine, poplar, cedar, basswood, and fir. In some embodiments, the outer casing of the pencil may be constructed using mixtures of waxes including, among others, paraffin, soy, bees wax, and coconut wax, thus enhancing fire sustainability.

The construction of the pencil may vary. In some embodiments, the outer casing may be a single body. In some embodiments, the outer casing of the pencil may include two or more portions joined with an adhesive or outer skin. The cross-sectional shape of the pencil may be any conventional pencil cross-sectional shape, such as circular, triangular, hexagonal, flat, or rectangular.

The method of manufacture may vary. In some methods, manufacture may be achieved by drilling a center cavity and press fitting graphite in an inner cavity. In some methods, manufacture may be achieved by producing two or more portions of the outer casing, placing graphite in an inner cavity, and joining the two or more portions together with an adhesive with the graphite encased. In some embodiments, manufacture may be achieved by producing two or more portions of the outer casing, placing graphite in an inner cavity, and joining the two or more portions together with an outer skin to compress the portions together with the graphite encased.

The pencil may include any grade graphite, and the graphite may be centered or uncentered. The pencil may include a ferrule to further attach an eraser or any additional accessories that may be relevant in an outdoorsman’s kit. The outer casing of the pencil may include engravings. The engravings may serve as indicia of a brand or trademark, or it may serve to provide information, such as common distress signals or directions for use.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations as further illustrated in the accompanying drawings and defined in the appended claims.

These and various other features and advantages will be apparent from a reading of the following Detailed Description.

### BRIEF DESCRIPTION OF THE DRAWINGS

The preferred and other embodiments are disclosed in association with the accompanying drawings in which:

FIG. 1 illustrates a perspective view of an embodiment of the tinder pencil in accordance with aspects of the present disclosure.

FIG. 2 illustrates a perspective exploded view of an embodiment of the tinder pencil in accordance with aspects of the present disclosure.

FIG. 3 illustrates a perspective view of an embodiment of the tinder pencil and a scraping tool in accordance with aspects of the present disclosure.

FIG. 4 illustrates a perspective view of an embodiment of the tinder pencil and a fire-starting tool in accordance with aspects of the present disclosure.

FIG. 5 illustrates a perspective view of an embodiment of the tinder pencil and a fire-starting tool in accordance with aspects of the present disclosure.

FIG. 6 illustrates a front and top view of an embodiment of the tinder pencil with a hexagonal construction.

FIG. 7 illustrates a front and top view of an embodiment of the tinder pencil with a triangular construction.

FIG. 8 illustrates an embodiment of the tinder pencil with a ferrule, eraser, and pocket clip attachment.

FIG. 9 is a flowchart of a method of use for a tinder pencil.

FIG. 10 is a flowchart of a method of manufacturing a tinder pencil.

### DETAILED DESCRIPTION

In the following description, for the purposes of explanation, numerous specific details are set forth to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with some other implementations as well. Similarly, however, no single feature or features of any described implementation should be considered essential to the invention as some implementations of the invention may omit such features.

Starting and sustaining a fire serves a myriad of purposes, including providing: heat, food preparation, smoke generation for food preservation, sterilization of materials, water purification, crafting pottery and tools, illumination, insect and predator deterrence, and distress signals. In certain circumstances, it can be difficult to start a fire and/or to sustain a fire.

The disclosed technology includes a fire-starting tinder pencil apparatus and methods of using and making the tinder pencil fire-starting apparatus. The versatility of pencils makes them invaluable tools for camping and survival scenarios. Whether writing notes or sketching maps, pencils aid in communication and navigation, enhancing situational awareness. In emergencies, pencils can serve as makeshift compasses or splints and their graphite cores can be used for writing messages or marking trails. Pencils also find utility in crafting makeshift tools or fishing gear. Their lightweight and durability make them ideal additions to any survival kit, providing a reliable means of documentation, navigation, and resource improvisation in the wilderness.

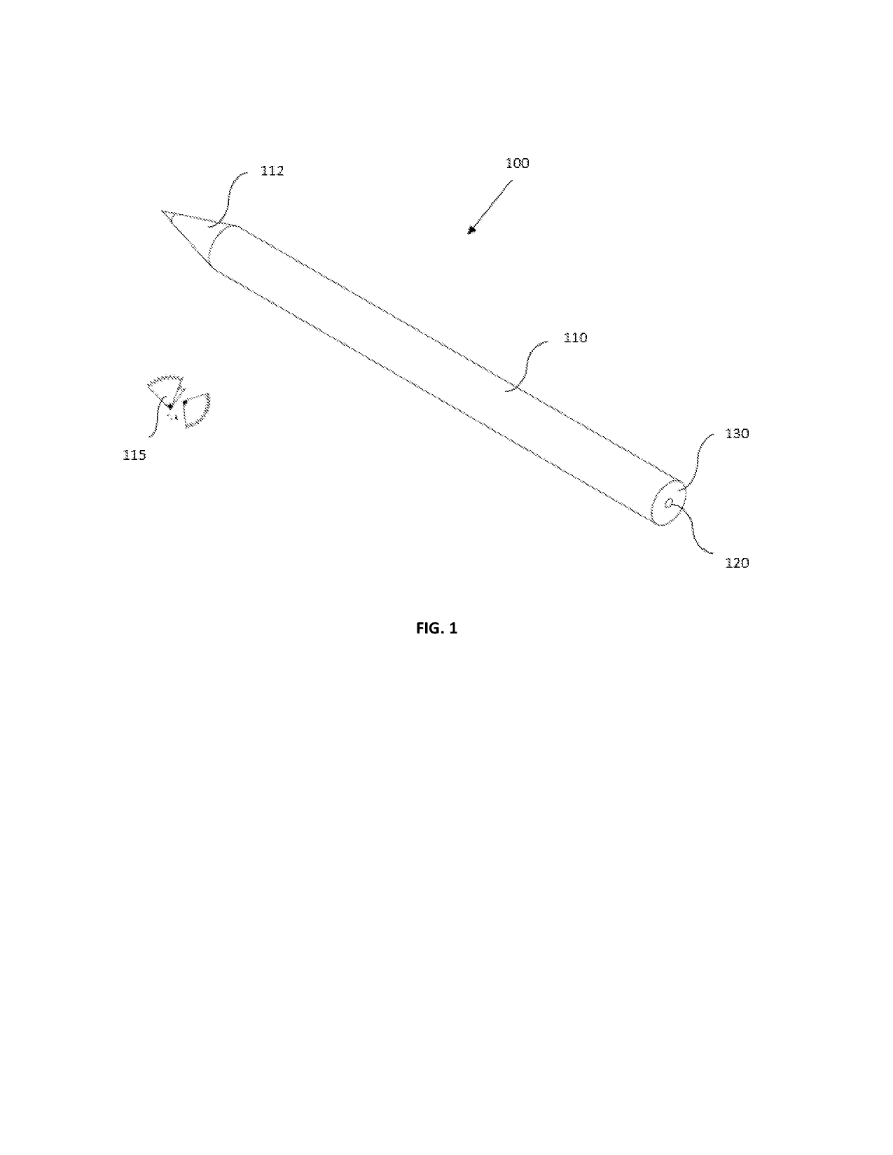

FIG. 1 illustrates a perspective view of an embodiment of the pencil in accordance with aspects of the present disclosure. In the illustrated embodiment, the pencil 100 is in a circular cross-sectional shape 130. The cross-sectional shape of the pencil may be any conventional pencil cross-sectional shape, such as circular, triangular, hexagonal, flat, or rectangular. Each cross-sectional shape may provide unique advantages in field use. A hexagonal shape may prevent the pencil from rolling on uneven surfaces, such as rocks or sloped terrain, while offering flat faces that are easier to grip or scrape. A triangular profile may be particularly useful for tactile orientation in low-light or no-visibility conditions, allowing the user to distinguish tool orientation by feel alone. A flat or rectangular shape may increase the contact area between the pencil and a scraping tool, producing broader tinder flakes ideal for rapid fire-starting. In the illustrated embodiment, the outer casing 110 is a single body.

The outer casing 110 may be constructed using natural wood such as, but not limited to, pine, poplar, cedar, basswood, and fir. In some embodiments, the outer casing may be constructed from high-resin wood species such as fatwood, juniper heartwood, or birch bark laminate, for their ignition properties and resin-rich fibers. These woods may be selected for flammability, structural integrity, moisture resistance, and compatibility with hand tools.

The outer casing 110 may be enriched, impregnated, or surface-treated with natural or synthetic resins such as pine rosin, dammar, alkyd, or epoxy-based formulations. Resin enrichment may be achieved through soaking, vacuum impregnation, brush coating, or heat-fused lamination processes. The placement of resin may be localized or uniform and may enhance water resistance and promote sustained combustion of the tinder shavings.

The outer casing 110 may be constructed using mixtures of waxes including, among others, paraffin, soy, bees wax, and coconut wax. The construction of the tinder pencil 100 and outer casing 110 may be designed such that tinder 115 will exhibit advantageous characteristics for fire starting such as increased burn duration and sustainability, increased flammability, increased water-resistance, enhanced oxygen flow, finer shavings, and the like when compared to a conventionally constructed pencil. Additional additives may be incorporated into the casing to improve performance. These may include magnesium flakes, powdered charcloth, or powdered oxidizers in low concentrations to accelerate ignition. In some embodiments, natural oils such as linseed oil or tung oil may be added to increase water repellency and improve burn quality.

The tinder 115 resulting from the sharpened outer casing 112 serve as effective tinder for starting fires. Additionally, the outer casing 110 of the pencil can be scraped, rubbed, grinded, or otherwise abrased along the entire surface of the outer casing 110 to create tinder 115 that ignites easily with a spark or lighter. The tinder produced from the outer casing 110 may be characterized by specific flammability metrics, including time to ignition (e.g., typically under 2 seconds with a spark), flame sustainability (e.g., burning for 10–30 seconds per shaving depending on thickness), and maximum flame height (e.g., up to 2–4 inches for curled shavings in still air). These performance characteristics may be enhanced by adjusting the resin or wax content and the shaving geometry.

In the embodiment of FIG. 1, manufacture may be achieved by drilling a center cavity and press fitting writing component 120 in the center cavity, among other methods. The writing component may be any component suitable for writing, such as graphite, charcoal, watercolor, grease, and the like. The grade of graphite may also be varied across different product versions. Softer grades (e.g., 6B) may be used for bold, dark writing or sketching on rough surfaces, while harder grades (e.g., 2H) may provide precision for cartographic or engineering use. Colored writing cores may include non-toxic pigments or be UV-reactive for low-light trail marking and signaling. In some methods of manufacture, a cavity for press fitting writing component 120 may not be in the center.

Other configurations of the tinder pencil as illustrated in FIG. 1 are contemplated, including ferrules to further attach erasers or additional accessories that may be relevant in an outdoors enthusiast kit. The outer casing 110 of the pencil may include engravings. The engravings may serve as indicia of a brand or trademark, or it may serve to provide information, such as common distress signals or directions for use, for example, morse code, distress signals, basic first-aid steps, or fire-starting instructions. These markings may be printed, laser-etched, or stamped into the casing and may be permanent or glow-in-the-dark to support use in low-visibility conditions. Further, color schemes of the casing may be selected to enhance visibility or camouflage depending on intended use. High-visibility orange, neon yellow, or reflective striping may be used in search and rescue contexts, while matte olive drab, tan, or charcoal may be used for military or hunting applications. In some configurations, contrasting tips or ends may visually designate which side contains the writing core and which is intended for tinder generation.

A flame-retardant band may optionally be included on one or both ends of the pencil to prevent unintentional combustion beyond the tinder zone. This band may consist of an intumescent paint, a clay-based coating, or a fire-retardant resin strip that self-extinguishes when exposed to flame.

Water resistance may be imparted to the outer casing via full-body wax impregnation or surface coatings. In some embodiments, the tinder pencil may be submerged in water for several minutes and still produce viable tinder upon drying the surface and shaving the material. This enables functionality in wet survival scenarios or high-humidity environments.

Furthermore, multiple pencils may be bundled as part of a tiered fire-starting kit, with each pencil offering different characteristics. For example, one pencil may contain a resin-infused wood casing for high-flame ignition, while another features a wax-dominant casing optimized for longer burn time. Color-coded tips or engravings may indicate the intended function of each pencil in the kit.

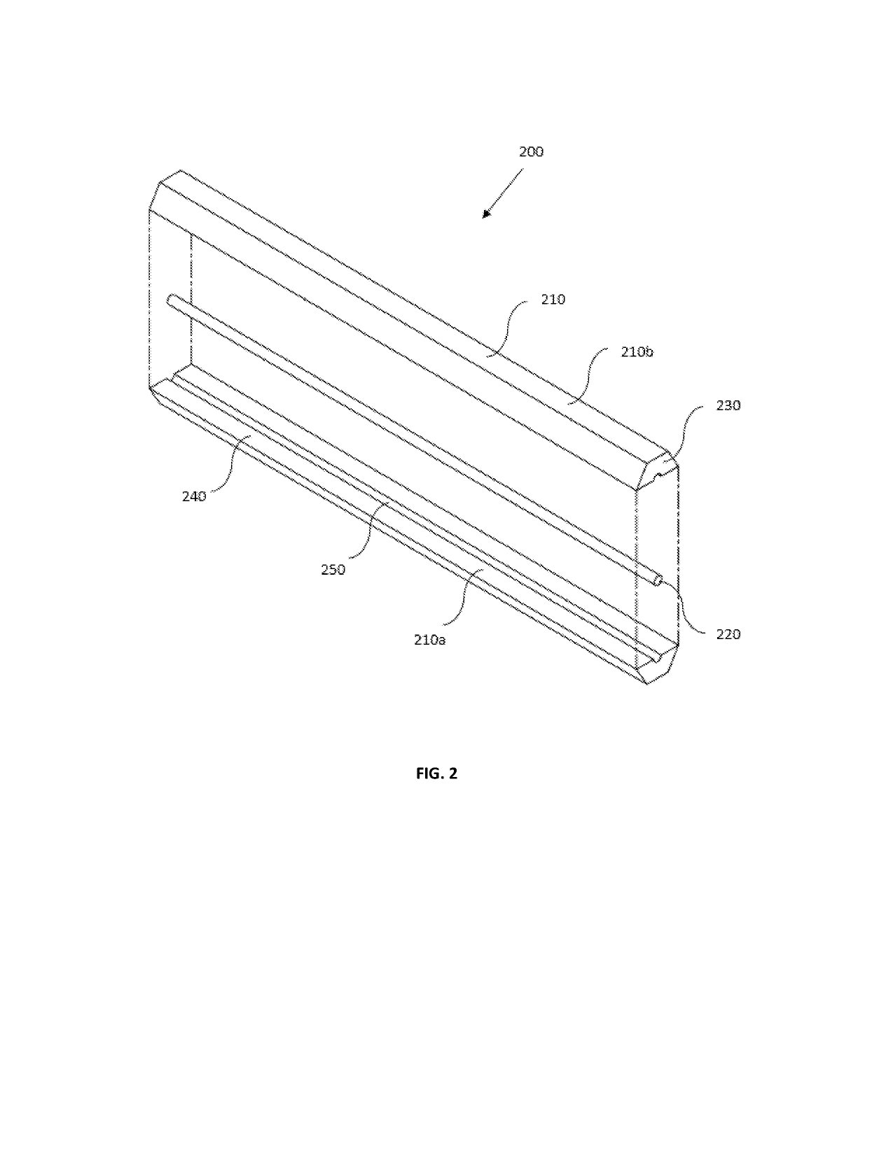

FIG. 2 illustrates a perspective exploded view of an embodiment of the tinder pencil in accordance with aspects of the present disclosure. In the illustrated embodiment, the pencil 200 is in a hexagonal cross-sectional shape 230. In the illustrated embodiment, the outer casing 210 is two portions, 210a and 210b. The outer casing 210 may be constructed using natural wood such as, but not limited to, pine, poplar, cedar, basswood, and fir. The outer casing 210 may be enriched with resin. The outer casing 210 may be constructed using mixtures of waxes including, among others, paraffin, soy, bees wax, and coconut wax.

In the embodiment of FIG. 2, manufacture may be achieved by producing two portions of the outer casing, 210a and 210b; placing writing component 220 into an inner cavity 250; and joining the two portions together with an adhesive at surface 240 with the writing component 220 encased. In some embodiments, more than two portions of the outer casing 210 may be joined with an adhesive. In some embodiments, manufacture may be achieved by producing two or more portions of the outer casing 210 and joining the two or more portions together with an outer skin to compress the portions together with the writing component 220 encased. The overall length and diameter of the pencil may also be varied. For example, shorter pencils may be optimized for pocket-sized survival kits, while extended-length models may provide longer burn time and more surface area for shaving.

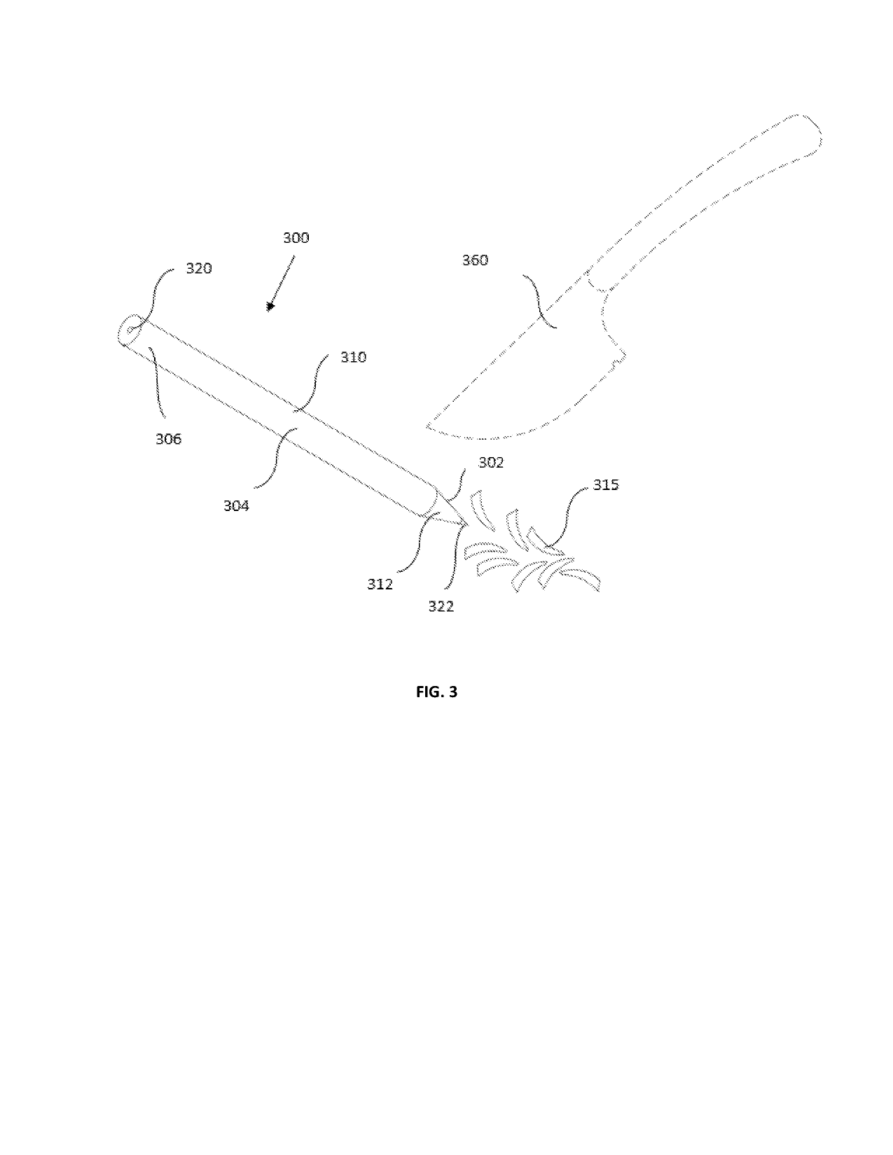

FIG. 3 illustrates a perspective view of an embodiment of the tinder pencil and a scraping tool in accordance with aspects of the present disclosure. In FIG. 3, the outer casing 310 of a tinder pencil 300 has been shaved to produce tinder 315 with a shaving tool 360. In the illustrated embodiment, the scraping tool 360 is a knife. The scraping tool 360 may be any tool, object, or surface used to scrape the outer casing 310 to produce tinder 315. For example, the scraping tool may be a knife, a rock, a piece of metal, a hard surface, etc. A scraping tool 360 is not required to produce tinder 315. For example, the outer casing 310 of a tinder pencil 300 may be broken into pieces by hand to produce tinder 315. In some embodiments, the tinder pencil may include pre-scored break lines or notches integrated into the outer casing at regular intervals. These may serve as controlled breakpoints to facilitate manual tinder production by snapping off shavings or chunks of material without tools. The break lines may be marked visually or include weakened regions formed by laser scoring, partial cuts, or structural indentations.

In the illustrated embodiment of FIG. 3, a sharpened outer casing 312 and sharpened writing component 322 may be seen at a first end 302. In some embodiments, the tinder 315 may be produced in the act of sharpening the tinder pencil 300, but tinder 315 may also be produced without sharpening the pencil. For example, the scraping tool 360 may be used on the middle section 304 of the outer casing 310 without exposing writing component 320. In some embodiments, a second end 306 may include a ferrule or other attachment mechanism to further attach erasers or additional accessories that may be relevant in an outdoors enthusiast kit, such as a scraping tool 360 or a fire-starting tool.

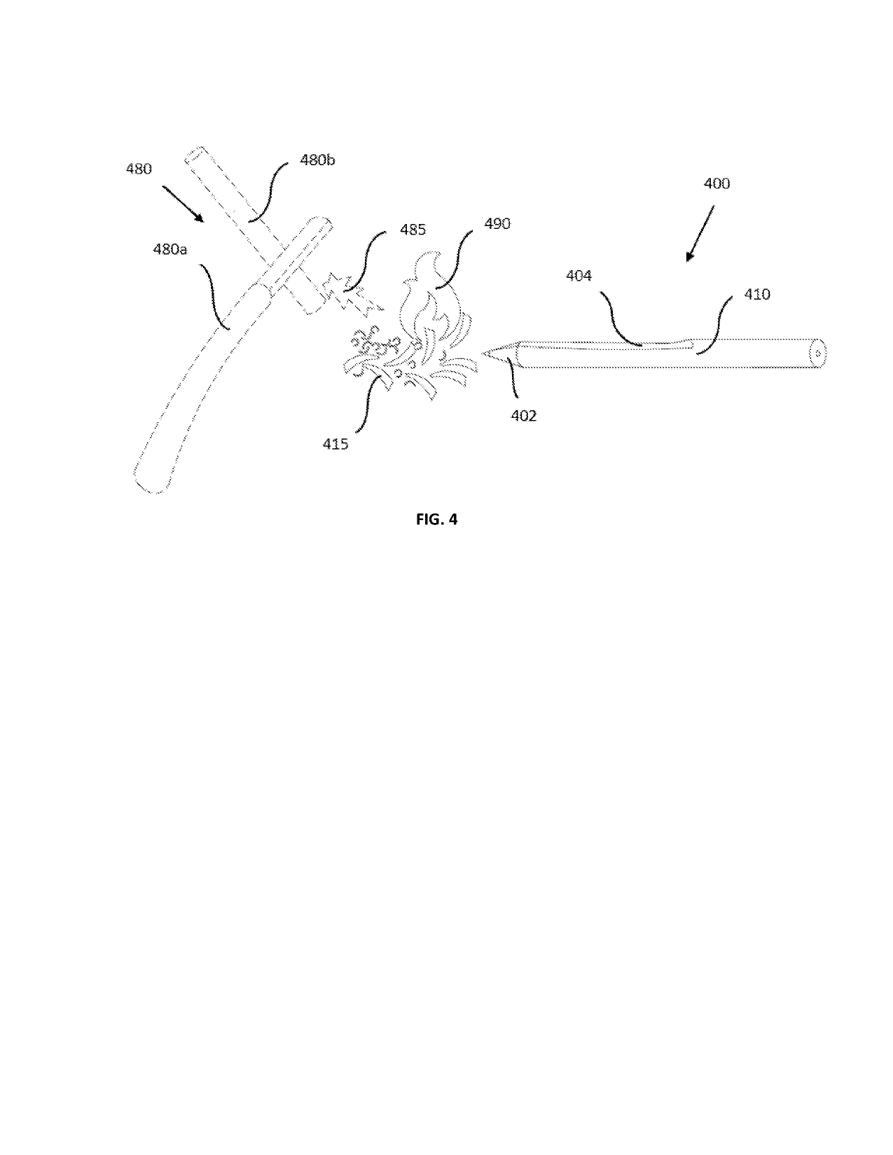

FIG. 4 illustrates a perspective view of an embodiment of the tinder pencil and a fire-starting tool in accordance with aspects of the present disclosure. In the illustrated embodiment, the outer casing 410 of the tinder pencil 400 has been scraped from middle section 404 to a first end 402 to produce tinder 415. The outer casing 410 of the tinder pencil 400 may be abrased, scraped, scratched, broken, or the like at any portion or in any way to produce tinder 415.

A fire-starting tool 480 may be used to produce spark 485. In the illustrated embodiment of FIG. 4, the fire-starting tool is a flint rod 480band a striker 480a. The fire-starting tool 480 may be any tool used to start fire, such as a lighter, a rod and striker, a match, and the like. Once the spark 485 meets the tinder 415 from the outer casing 410, a fire 490 may be produced.

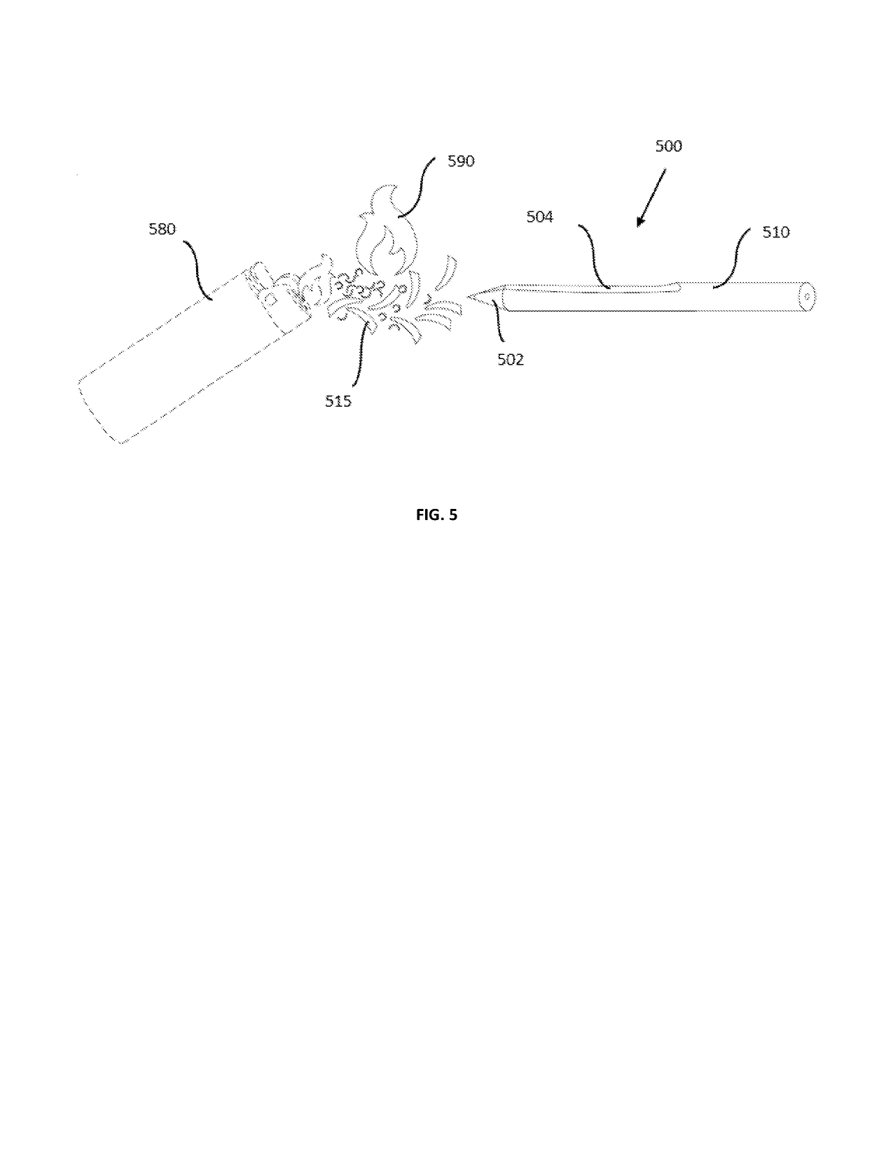

FIG. 5 illustrates a perspective view of an embodiment of the tinder pencil and a fire-starting tool in accordance with aspects of the present disclosure. In the illustrated embodiment, the outer casing 510 of the tinder pencil 500 has been scraped from middle section 504 to first end 502 to produce tinder 515. As described previously, the outer casing 510 of the tinder pencil 500 may be abrased, scraped, sharpened, or broken at any portion or in any way to produce tinder 515. In the illustrated embodiment of FIG. 4, the fire-starting tool 580 is a lighter. The fire-starting tool 580 may be used to ignite the tinder 515, producing a fire 590.

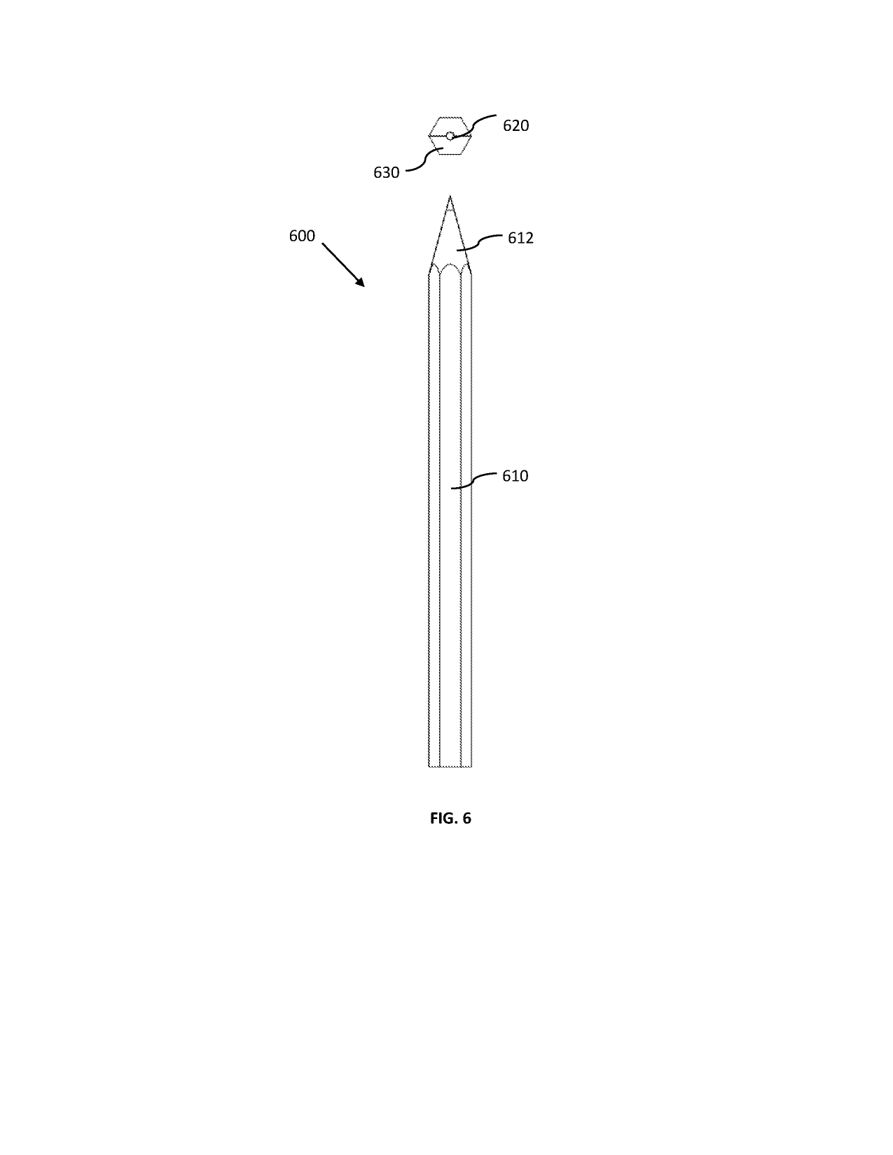

FIG. 6 illustrates a front and top view of an embodiment of the tinder pencil 600 with a hexagonal construction. Outer casing 610 and sharpened outer casing 612 can be seen in the front view. The writing component 620 and hexagonal cross section 630 can be seen in the top view.

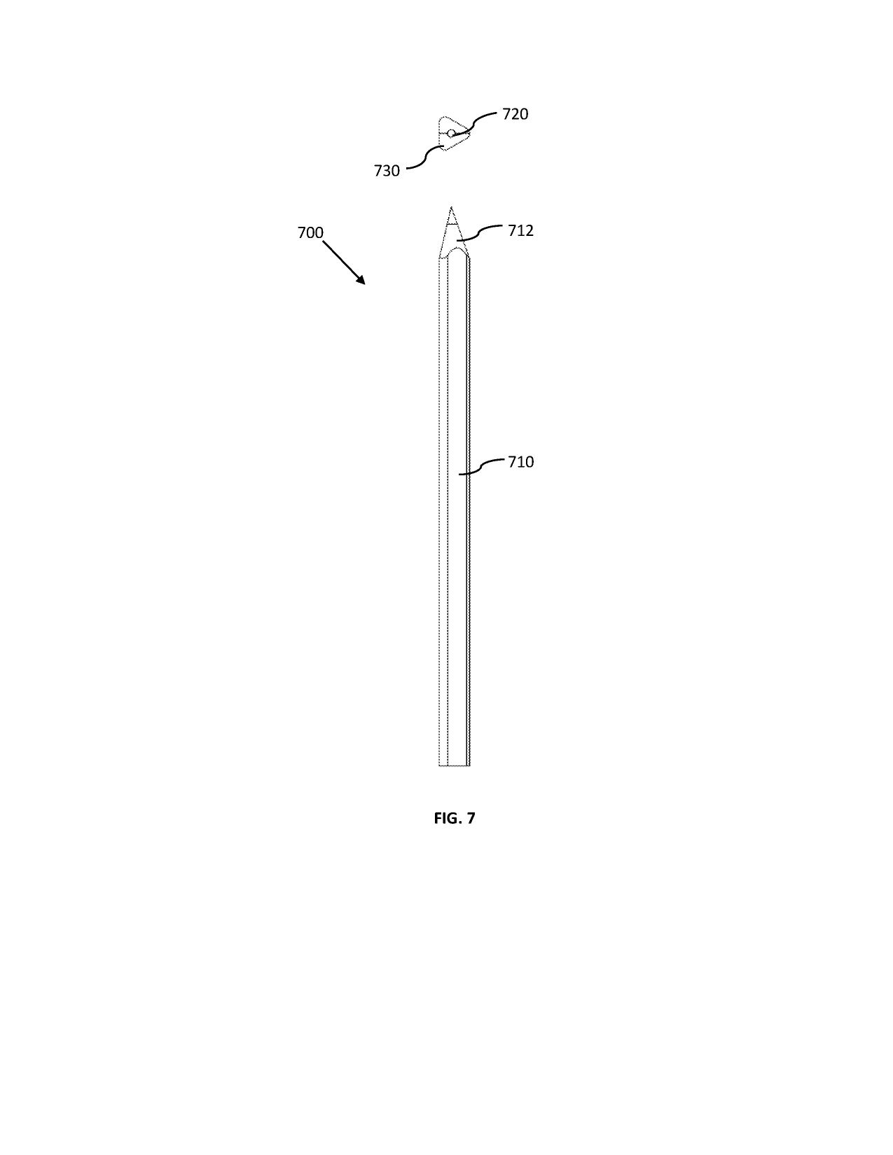

FIG. 7 illustrates a front and top view of an embodiment of the tinder pencil 700 with a triangular construction. Outer casing 710 and sharpened outer casing 712 can be seen in the front view. The writing component 720 and triangular cross section 730 can be seen in the top view.

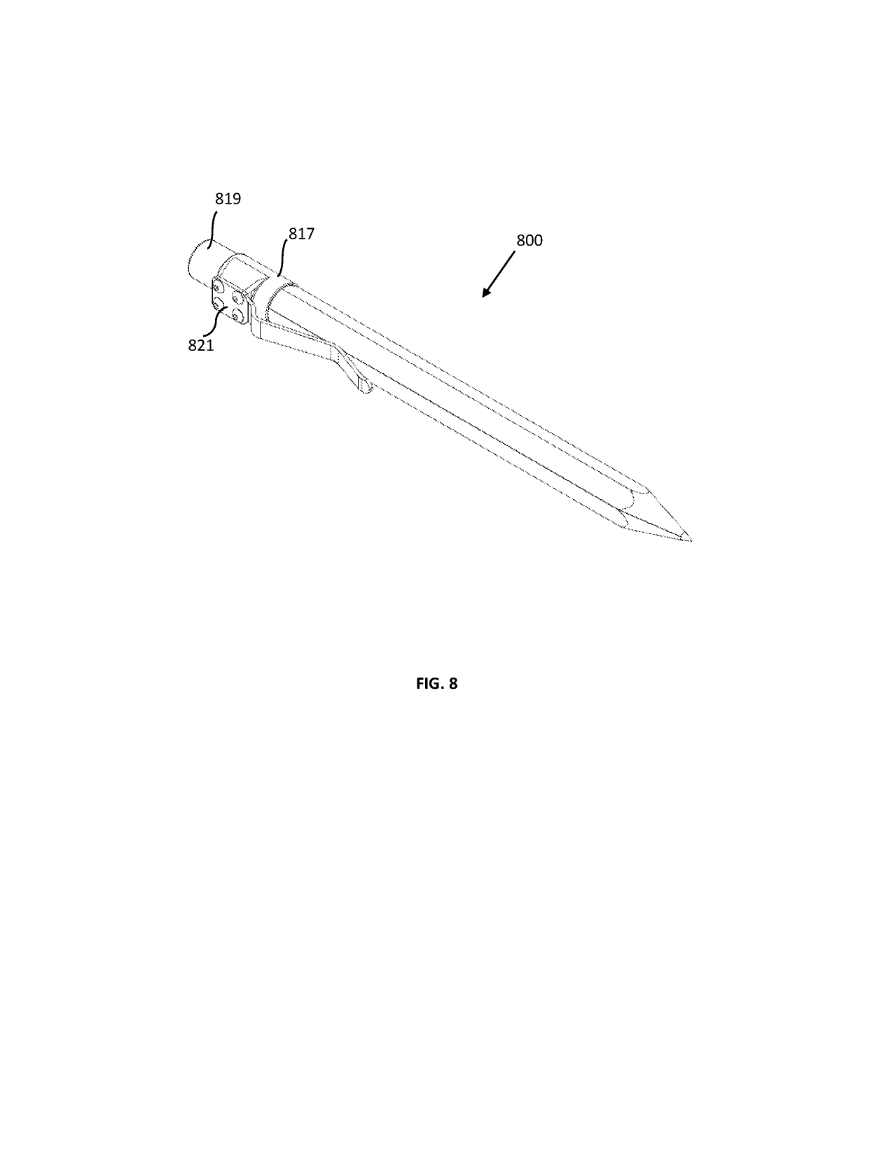

FIG. 8 illustrates an embodiment of the tinder pencil 800 with a ferrule 817 , eraser 819, and pocket clip attachment 821. In some embodiments, the tinder pencil may be configured to directly integrate with one or more ignition mechanisms to create a self-contained fire-starting solution. For example, the pencil may include a ferrule or cap with an embedded ferrocerium nub, allowing the pencil itself to serve as the striking surface for spark generation when paired with a metal scraper or sharp edge. The pocket clip attachment 821 may be made of a material suitable for creating a spark, such that when the pocket clip is stricken against a spark rod (e.g., ferrocerium rod) or ferrocerium nub, it will create a spark into the tinder produced by the tinder pencil.

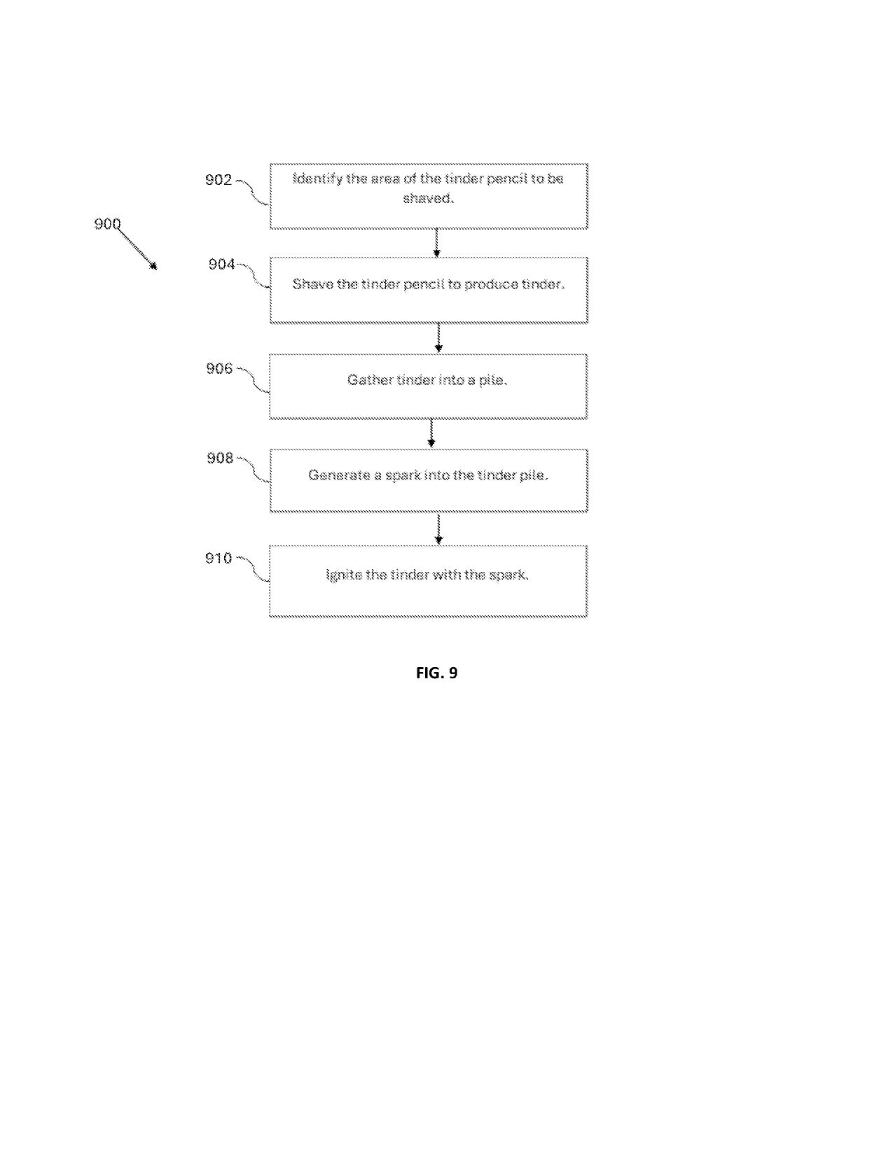

FIG. 9 is a flowchart of a method of use 900 for a tinder pencil. In use, the tinder pencil may be employed to both create ignition material and function as a writing tool. At 902, a user may first identify the desired area of the outer casing to be shaved or scraped. At 904, the user may use a sharp edge, such as a knife, scraping tool, or even a rock, to abrade the casing along its longitudinal surface, at its tip, or at any suitable portion to produce thin shavings or tinder. At 906, the produced tinder may then be gathered into a pile or collected directly into a fire-starting zone, such as beneath kindling. At 908, once sufficient tinder is gathered, the user may generate a spark or flame using a fire-starting source. The fire-starting source may include, but is not limited to, a lighter, a match, or a ferrocerium rod struck with a steel or ceramic striker. At 910, when the generated spark or flame contacts the tinder shavings, ignition occurs, initiating combustion. In some embodiments, the user may utilize visual indicators or engravings on the pencil casing to identify the intended scraping zones or the proper orientation for use in darkness or adverse conditions. The writing core may be used before or after tinder generation to mark surfaces, write notes, or signal for help.

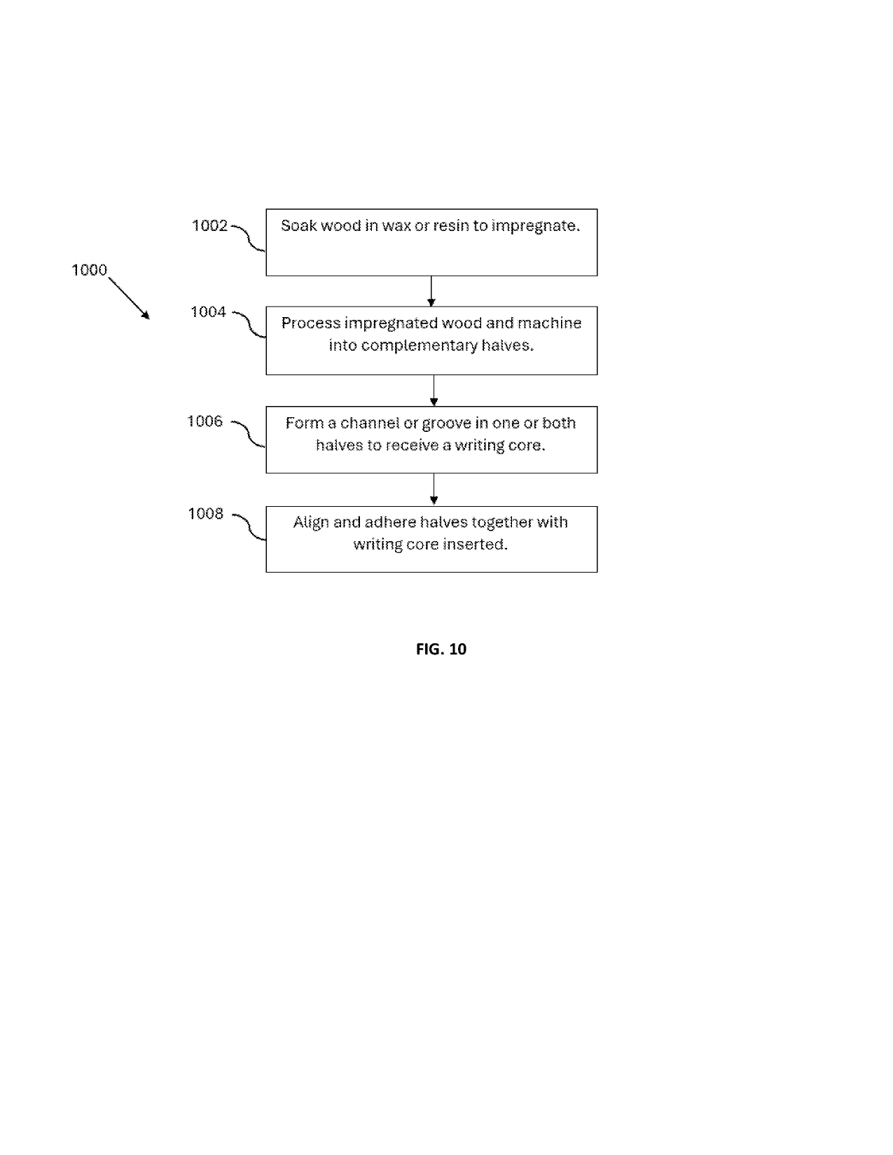

FIG. 10 illustrates a method of manufacturing 1000 a tinder pencil. In the method of FIG. 10, the tinder pencil is manufactured using a process involving resin or wax impregnation. At 1002, the wood is soaked in an open container of melted wax or resin. The wood wicks the molten wax or resin solution due to its porosity and capillary structure. At 1004, once sufficiently impregnated, the wax-infused or resin-infused wood may be processed into flat sheets or blanks to be machined into complementary halves, each shaped to form part of the outer casing. At 1006, a channel or groove may be formed in one or both halves to receive a writing core, such as graphite. At 1008, the two halves are then aligned and adhered together—such as with wood glue or thermoplastic adhesive—thereby encasing the writing core within the center of the pencil. A clear coating or other sealant may be applied to prevent leaching of wax or resin under certain conditions, such as high temperatures.

In an alternative approach, the wax or resin impregnation process may occur after the pencil has been assembled. In such cases, the fully formed pencil—prior to any surface painting or finishing—may be immersed into a bath of melted wax or resin. The outer casing absorbs the wax or resin, enhancing its flammability and water resistance. After soaking, the pencil may be cooled and optionally coated with a clear varnish or sealant to prevent wax or resin leaching under high temperatures (e.g., inside a vehicle on a hot day).

In some embodiments of the method, to improve the depth of wax or resin infusion, the wood blanks may also be treated under vacuum or in an autoclave chamber. This pressurization technique enhances the absorption of the wax or resin solution into the wood fibers and may be particularly useful for harder woods or composite formulations.

Optional accessories, such as ferrules or end caps, may be press-fit, crimped, or adhered to one end of the pencil to allow for attachment of erasers, strikers, or additional survival components. Engravings or markings may be added via laser etching, hot stamping, or ink printing, and may include instructions, branding, or signaling codes.

The above specification, examples, and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims. While embodiments and applications of this invention have been shown, and described, it would be apparent to those skilled in the art having the benefit of this disclosure that many more modifications than mentioned above are possible without departing from the inventive concepts herein. The invention, therefore, is not to be restricted except in the spirit of the appended claims.

The embodiments of the disclosure are drafted such that various different embodiments may be combined as set forth, for example, in the multiple dependency of the claims that follow. Every combination of embodiments that is grammatically, mathematically, and logically consistent is contemplated. The skilled person may identify one or more combinations of embodiments that are unfeasible, and the existence of any such unfeasible combination shall not limit any combination of embodiments that the skilled person would identify as feasible in light of this disclosure.

The methods described in this disclosure include examples of implementations, and the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference.

The description set forth herein describes example configurations and does not represent all the examples that may be implemented or that are within the scope of the claims. The detailed description includes specific details for the purpose of providing an understanding of the described techniques. These techniques, however, may be practiced without these specific details.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A tinder pencil, comprising:
an outer casing configured to produce flammable tinder; and
a writing component enclosed with the outer casing.

2. The tinder pencil of claim 1, wherein the outer casing is enriched with a wax or resin to improve flammability.

3. The tinder pencil of claim 1, wherein the outer casing comprises a wax-based material selected from the group consisting of paraffin, soy wax, beeswax, and coconut wax.

4. The tinder pencil of claim 1, further comprising engravings on the outer casing, the engravings providing survival instructions, distress signals, or branding.

5. The tinder pencil of claim 2, wherein the outer casing is clear coated to prevent leaching of the wax or resin.

6. The tinder pencil of claim 1, further comprising:
a ferrule to integrate one or more attachments.

7. The tinder pencil of claim 6, wherein the one or more attachments include, an eraser, a striker, a ferrocerium nub, or a pocket clip.

8. The tinder pencil of claim 1, wherein the outer casing is water resistant.

9. A method of manufacturing a tinder pencil, comprising:
impregnating wood with wax or resin;
machining the impregnated wood into complementary halves;
forming a channel in the complementary halves to receive a writing core;
inserting the writing core into the channel;
aligning the complementary halves; and
adhering the complementary halves together.

10. The method of claim 9, further comprising:
applying a clear coat to the tinder pencil.

11. The method of claim 10, wherein the clear coat is configured to prevent the wax or resin from leaching out of the tinder pencil.

12. The method of claim 9, further comprising:
attaching a ferrule to the tinder pencil.

13. The method of claim 12, further comprising:
attaching an eraser, a striker, a ferrocerium nub, or a pocket clip to the ferrule.

14. The method of claim 9, further comprising:
adding engravings or markings to the tinder pencil.

15. The method of claim 14, wherein the engravings or markings include instructions, branding, signaling codes, or survival tips.

16. The method of claim 9, wherein the complementary halves form a circular, hexagonal, triangular, rectangular, or flat cross-sectional shape when adhered together.

17. A tinder pencil, comprising:
a writing component;
an outer casing enclosing the writing component and configured to produce flammable tinder, the outer casing including resin or wax; and
a ferrule to attach one or more of an eraser, a striker, a ferrocerium nub, and a pocket clip.

18. The tinder pencil of claim 17, wherein the outer casing comprises a natural wood selected from pine, cedar, fir, basswood, and poplar.

19. The tinder pencil of claim 17, wherein the wax includes paraffin, soy wax, beeswax, or coconut wax.

20. The tinder pencil of claim 17, further comprising:
a clear coat configured to prevent leaching of the resin or wax.
